(19) United States
(12) Patent Application Publication
(10) Pub. No.: US 2026/0266380 A1
(43) Pub. Date: Sep. 10, 2026

(54) LARGE-DIAMETER IN-LINE SEAL COMPRISING A SEALING PLATE

(71) Applicant: ONIS, Lambesc (FR)

(72) Inventor: Yann FUMANAL, Pelissanne (FR)

(73) Assignee: ONIS, Lambesc (FR)

(21) Appl. No.: 18/993,807

(22) PCT Filed: Sep. 1, 2023
(86) PCT No.: PCT/EP2023/074079

§ 371 Date: Jan. 13, 2025

(30) Foreign Application Priority Data
Sep. 7, 2022 (FR) 2208940

(51) Int. Cl. F16K 3/20; F16K 3/312; F16K 27/04

(52) U.S. Cl. CPC F16K 3/312; F16K 3/20; F16K 27/044

(57) ABSTRACT

An in-line seal comprising a sealing plate that is able to move in a plane between a sealing position stopping fluid flow and a flow position allowing said fluid flow; a body comprising a first half-body and a second half-body arranged respectively on either side of said plane; and a clamping/separating system for clamping and, conversely, for separating at least one clamping piece with respect to said sealing plate. According to the invention, said clamping/separating system comprises a first thrust ring, a second thrust ring, at least one assembly that is elastically deformable by compressing comprising a helical spring and a guide shaft, said at least one assembly being arranged between said first thrust ring and said second thrust ring.

### CROSS-REFERENCE TO RELATED APPLICATIONS

This application is the U.S. national phase of PCT Application No. PCT/EP2023/074079 filed on Sep. 1, 2023, which claims priority to French patent application No. FR 2208940 filed on Sep. 7, 2022, the disclosures of which are incorporated in their entireties by reference herein.

### TECHNICAL FIELD

The present disclosure relates to the field of in-line seals generally intended to be arranged on pipes or ducts and that, by means of a sealing plate, allow a fluid to flow or be stopped inside the pipes or ducts.

### BACKGROUND

In a manner that is known, such a sealing plate may be able to move in translation or in rotation in relation to a body of the in-line seal. Such in-line seals have been described, in particular, in documents FR 3 041 407, FR 3 051 878 and FR 3 080 665.

Known in-line seals comprise clamping/separating means for simultaneously clamping and, conversely, separating a first half-body and a second half-body in relation to the sealing plate.

Such in-line seals are designed for pipes of small and average dimensions, for example having a fluid flow cross section with a diameter less than or equal to 1300 mm (millimeters). These in-line seals need the pipes to be able to deform elastically via the clamping/separating means, that are generally actuated manually by an operator.

However, for pipes with large dimensions, for example having a fluid flow cross section with a diameter greater than 1300 mm (millimeters), other types of in-line seals have been developed and do not need the pipes to be able to deform elastically.

This type of in-line seal for pipes with large dimensions comprises a clamping/separating system for clamping and, conversely, for separating at least one clamping piece that is able to move in relation to the body according to at least one degree of freedom to move in translation. Such a degree of freedom to move in translation of the clamping piece or pieces is oriented in a direction of translation parallel to the direction of fluid flow in the body of the seal.

Such a body comprises a first half-body and a second half-body that always remain stationary in relation to each other whereas the clamping piece moves in translation in the translation direction to clamp or release the sealing plate if necessary.

The clamping piece or pieces are arranged between the sealing plate and one of the half-bodies, that will be referred to hereinafter as the first half-body, for the sake of simplicity. This or these movable clamping pieces may of course alternatively be arranged between the sealing plate and the second half-body.

The clamping/separating systems may in particular comprise loaded U-shaped springs that are capable of torsional deformation in order to transmit a compression force to the clamping piece or pieces, depending on the translation direction.

However, if one of the U-shaped springs breaks, it is necessary to remove the in-line seal from the ducts and completely disassemble it in order to be able to replace the broken spring.

Such a maintenance operation is particularly complex and time consuming given the size and the very considerable weight of this type of in-line seal.

Documents FR 1 357 657, DE 22 27 386 and DE 27 19 164 disclose gas valves for tubes with a large cross section comprising a stop valve consisting of a seat and a closing piece.

Furthermore, these valves comprise a clamping/separating system for clamping and, conversely, for separating a clamping piece that is able to move in translation. Such a clamping/separating system comprises a plurality of assemblies that are elastically deformable by compressing, arranged equidistant from each other in azimuth about a translation direction of the clamping piece, each assembly being able to comprise a helical spring and a guide shaft.

However, as in the case of systems comprising U-shaped springs, if one of the helical springs breaks, it is necessary to remove the in-line seal from the ducts and completely disassemble it in order to be able to replace the broken spring.

### SUMMARY

An object of the present disclosure is thus to propose an alternative in-line seal provided with at least one clamping piece that is able to move in translation. Indeed, one aim of the disclosure is to provide a solution to allow maintenance operations to be carried out both simply and quickly on clamping/separating systems of such a type of in-line seal.

As already disclosed, the disclosure therefore relates to an in-line seal comprising:
a sealing plate that is able to move in a plane (P) between a sealing position preventing fluid flow in an internal zone of the in-line seal and a flow position allowing fluid flow in a direction of fluid flow, the sealing plate comprising a solid portion for preventing fluid flow and a perforated portion for allowing fluid flow;
a body comprising a first half-body and a second half-body arranged respectively on either side of the plane (P), the first and second half-bodies respectively having a first opening and a second opening allowing fluid flow; and
a clamping/separating system for clamping and, conversely, for separating at least one clamping piece, said at least one clamping piece being able to move in relation to the body according to at least one degree of freedom to move in translation in a direction of translation parallel to the direction of fluid flow, said at least one clamping piece being arranged between the sealing plate and the first half-body, the clamping/separating system comprising an elastically deformable sealing sleeve extending between the first half-body and said at least one clamping piece.

The clamping/separating system comprises a first thrust ring secured to the first half-body, a second thrust ring secured to said at least one clamping piece, a plurality of assemblies that are elastically deformable by compressing and arranged equidistant from each other in azimuth about the translation direction, each assembly comprising a helical spring and a guide shaft comprising an axis of revolution oriented parallel to the translation direction, the helical spring being arranged between the first thrust ring and the second thrust ring, the helical spring being arranged around the guide shaft.

According to the disclosure, in that the first thrust ring comprises several first sections arranged equidistant from each other in azimuth about the translation direction and the second thrust ring comprises several second sections arranged equidistant from each other in azimuth about the translation direction.

In other words, the clamping/separating system enables an operator to clamp or release the sealing plate when it is necessary to move it from its flow position to its sealing position or, conversely, from its sealing position to its flow position.

This clamping of the sealing plate then takes place between said at least one clamping piece and the second half-body. The first and the second half-bodies are fixed in relation to each other and said at least one clamping piece is free to move in translation in the translation direction between the first and second half-bodies.

The expression “the helical spring being arranged between the first thrust ring and the second thrust ring” means that the helical spring can transmit its thrust force to the first thrust ring and the second thrust ring directly or indirectly.

Therefore, the helical spring may come into direct contact with planar faces of the first thrust ring and the second thrust ring or may come into contact with an intermediate piece arranged in contact with the first thrust ring or the second thrust ring.

Furthermore, each deformable assembly is configured to be fitted on or removed from an in-line seal separately from the other deformable assemblies and without needing to remove the in-line seal from the ducts.

A worn, damaged or broken helical spring of a deformable assembly can therefore be replaced separately from the other deformable assemblies on an in-line seal fitted on ducts.

For this purpose, compression and/or gripping means may be used to compress and/or remove a deformable assembly. Once compressed, the deformable assembly can be removed in a direction radial to the direction of fluid flow of the in-line seal.

Moreover, the different assemblies are arranged symmetrically around the elastically deformable sealing sleeve extending axially in the translation direction between the first half-body and said at least one clamping piece.

Similarly, the first sections of the first thrust ring and the second sections of the second thrust ring are also arranged respectively symmetrically all the way around the elastically deformable sealing sleeve extending axially in the translation direction between the first half-body and said at least one clamping piece.

Furthermore, such an arrangement of the first and second thrust rings, in sections, also helps to ensure uniform thrust generated by the clamping/separating system between the sealing plate and the first half-body and to ensure optimal sealing.

The in-line seal may moreover comprise one or more of the following features, taken individually or in combination.

In practice, the guide shaft may comprise a head that has a degree of rotational freedom in relation to the second thrust ring, the degree of rotational freedom being about an axis of rotation that coincides with the axis of revolution.

Therefore, the guide shaft can pivot on itself about its axis of revolution. The guide shaft is guided in rotation by means of its head in relation to the second thrust ring.

Advantageously, the head may comprise a first shoulder bearing against a first end of the helical spring and against a first face of the second thrust ring.

The first shoulder of the head of the guide shaft thus forms an intermediate piece arranged in contact with the helical spring and the second thrust ring.

According to one embodiment of the disclosure, the first shoulder may comprise a plurality of holes arranged radially in relation to the axis of revolution and equidistant in azimuth, the plurality of holes allowing the guide shaft to be rotated about the axis of rotation and in relation to the second thrust ring with a tool.

The holes may advantageously have the same diameter and be blind holes. These holes then open only on an outer cylindrical face of the first shoulder. Such holes therefore allow an operator provided with the tool to pivot the guide shaft about the axis of rotation in order to compress a helical spring of a deformable assembly, if necessary.

Furthermore, such a tool may have, at at least one protrusion, a male cross section whose shape matches a female cross section of the plurality of holes. Such a tool may be in the form of a rod, an arm or a cylindrical bar capable of being inserted into each of the holes, one after another, after pivoting the guide shaft on itself by an angle of a few degrees, for example an angle of between 0 and 45 degrees.

In practice, said at least one assembly may comprise an axial stop secured to a cylindrical portion of the head, the cylindrical portion extending along the axis of revolution from the first shoulder, the cylindrical portion passing through a matching cylindrical bore provided in the second thrust ring, the axial stop comprising a second shoulder in contact with a second face of the second thrust ring, the second face being arranged parallel to the first face and perpendicular to the axis of revolution.

Such an axial stop and the second shoulder that it comprises therefore help hold the guide shaft axially in relation to the second thrust ring. Moreover, when the guide shaft is pivoted on itself about the axis of rotation, the second shoulder can then move towards the first thrust ring to compress the helical spring.

The cylindrical portion of the head cooperating with the matching cylindrical bore provided in the second thrust ring allows freedom of movement in rotation corresponding to the degree of rotational freedom of the guide shaft in relation to the second thrust ring.

Furthermore, such an axial stop may be attached and secured to a free end of the cylindrical portion of the head, once inserted into the cylindrical bore of the second thrust ring. Reversible securing means such as screws or nuts may allow the axial stop to be secured to the head of the guide shaft to form a one-piece assembly arranged in a pivot connection with a degree of rotational freedom about the axis of rotation in relation to the second thrust ring.

Advantageously, said at least one assembly may comprise a nut with a tapped bore screwed onto a threaded portion of the guide shaft, the nut being secured to the first thrust ring, i.e., without any degree of freedom, under a tensile reaction transmitted by the guide shaft to the nut.

Such a nut is arranged in a sliding connection with respect to the first thrust ring and also has an axial stop forming a flat bearing connection with the first thrust ring. One or more flat spots arranged on an outer face of the nut may thus help prevent the nut from rotating in relation to the first thrust ring about an axis of translation that coincides with the axis of revolution.

A third shoulder provided on the nut may form the axial stop and prevent a movement in translation along the axis of translation and two relative rotations of the nut and the first thrust ring about two axes perpendicular to each other and perpendicular to the axis of translation.

Tightening the guide shaft in the nut makes it possible to reduce the distance separating the head of the guide shaft from the first thrust ring and, therefore, to reduce the distance separating the first thrust ring and the second thrust ring.

Conversely, loosening the guide shaft in the nut makes it possible to increase the distance separating the head of the guide shaft from the first thrust ring and, therefore, to increase the distance separating the first thrust ring and the second thrust ring.

Advantageously, each assembly of the plurality of assemblies can cooperate with a first section of the first thrust ring and a second section of the second thrust ring, the first section being arranged opposite the second section along the axis of revolution of the guide shaft of the assembly.

In other words, when an assembly is removed from the in-line seal in order to replace a helical spring, a first section of the first thrust ring and a second section of the second thrust ring are also removed from the in-line seal.

Therefore, an assembly and a pair comprising a first section of the first thrust ring and a second section of the second thrust ring form a group of pieces that are linked to each other and can be deformed in compression and expansion along the axis of translation.

Furthermore, notches may be provided between each of the first sections and/or between each of the second sections in order to make it easier to radially install each of the groups of pieces next to each other around the translation direction.

According to another embodiment of the disclosure, the sealing sleeve may comprise a first annular portion cooperating with a first cylindrical portion of the first thrust ring and a second annular portion cooperating with a second cylindrical portion of the second thrust ring.

The first annular portion may thus be arranged coaxially with the second annular portion. These first and second annular portions may act as a support for the first and second cylindrical portions, respectively. Such annular portions may also allow each of the cylindrical portions of the first thrust ring and the second thrust ring to be centered and accurately positioned.

Moreover, such a sealing sleeve may comprise a deformable portion arranged between the first annular portion and the second annular portion. Such a deformable portion may also comprise corrugations formed by a metal sheet having symmetry of revolution centered around the translation direction of the in-line seal.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a perspective cross-sectional view of an in-line seal according to the disclosure;

FIG. 2 is a partial perspective view of a clamping/separating system equipping such a seal, according to the disclosure;

FIG. 3 is a partial perspective view of a clamping/separating system equipping such a seal, according to the disclosure;

FIG. 4 is a partial cross-sectional view of a clamping/separating system equipping such a seal, according to the disclosure;

FIG. 5 is another partial perspective view of a clamping/separating system equipping such a seal, according to the disclosure; and

FIG. 6 is another partial perspective view of a clamping/separating system equipping such a seal, according to the disclosure.

### DETAILED DESCRIPTION

Furthermore, elements that are present in more than one of the figures may be given the same references in each of them.

As already disclosed, the disclosure relates to an in-line seal comprising a sealing plate that is able to move in translation or in rotation between a sealing position stopping fluid flow through the in-line seal and a flow position allowing fluid flow.

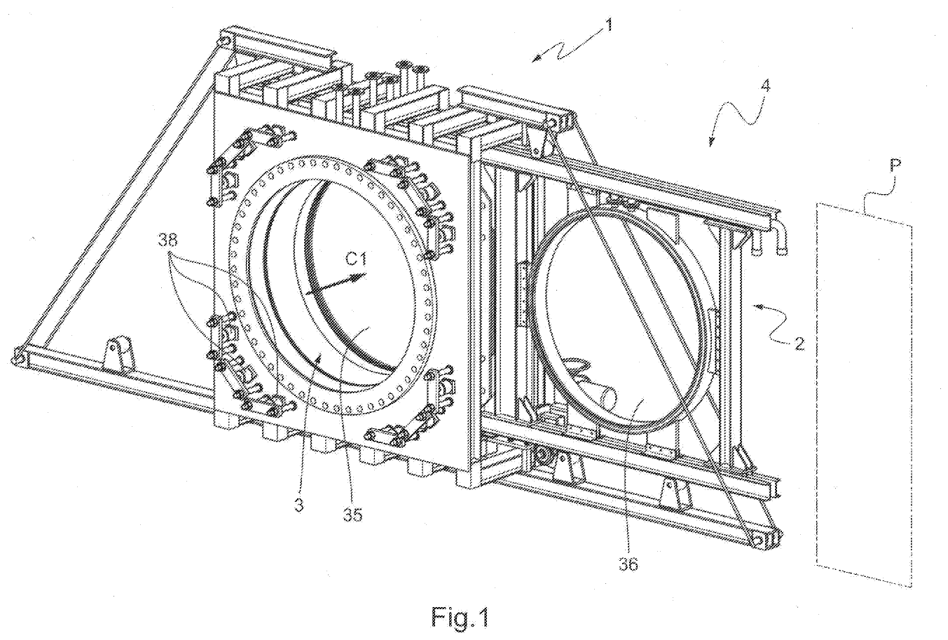

As shown in FIG. 1, such an in-line seal 1 therefore comprises a sealing plate 2 capable of moving at least in a plane P so as to allow or prevent fluid flow in an internal zone 3 of the in-line seal 1. In the flow position of the sealing plate 2, a perforated portion of the sealing plate 2 allows fluid flow in a direction of fluid flow C1.

The sealing plate 2 also comprises a solid portion for preventing fluid flow, for example in order to perform a maintenance operation on a duct arranged downstream of the in-line seal 1 in the direction of fluid flow C1. Such a solid portion 35 is in this instance shown to be positioned in the internal zone 3 of the in-line seal 1, while the perforated portion 36 is shown in an external zone 4 of the in-line seal 1.

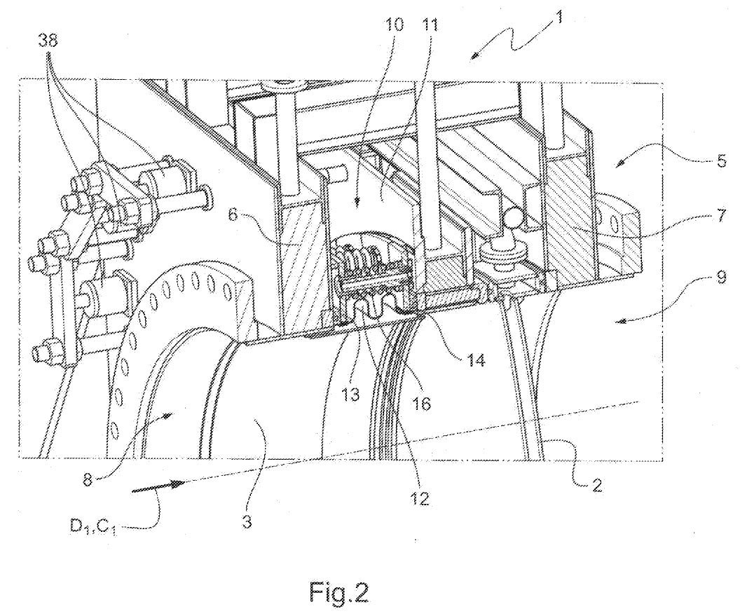

Furthermore, as shown in FIG. 2, the in-line seal 1 also comprises a body 5 comprising a first half-body 6 and a second half-body 7 arranged respectively on either side of the plane P. Such a first half-body 6 and second half-body 7 are arranged secured to each other and therefore have no degree of freedom between then.

The first half-body 6 therefore has a first opening 8 and the second half-body 7 has a second opening 9 allowing fluid flow through the in-line seal 1 when the perforated portion is positioned in the internal zone 3 of the in-line seal 1.

The in-line seal 1 also comprises a clamping/separating system 10 for clamping and, conversely, for separating at least one clamping piece 11. This or these clamping pieces 11 are able to move in relation to the body 5 according to at least one degree of freedom to move in translation in a direction of translation D1 parallel to the direction of fluid flow C1. Manual or motorized control means, such as hydraulic actuators 38, for example, therefore allow the clamping piece or pieces 11 to be moved in relation to the body 5.

Moreover, this or these clamping piece or pieces 11 are in this instance positioned between the sealing plate 2 and the first half-body 6. However, inverting the orientation of the in-line seal 1 in relation to the direction of fluid flow C1 can invert the relative positioning of the first half-body 6 and second half-body 7. Therefore, without departing from the subject matter of the disclosure, this or these clamping piece or pieces 11 may also be positioned between the sealing plate 2 and the second half-body 7.

A clamping/separating system 10 also comprises an elastically deformable sealing sleeve 12 extending between the first half-body 6 and the clamping piece or pieces 11. This sealing sleeve 12 helps to prevent the fluid present in the internal zone 3 of the in-line seal 1 from leaking out, irrespective of the position of the clamping piece or pieces 11 in relation to the body 5.

Such a clamping/separating system 10 also comprises a first thrust ring 13 secured to the first half-body 6 under a compression force transmitted by a helical spring 16, 16′ to the first thrust ring 13 and a second thrust ring 14 secured to the clamping piece or pieces 11 under a compression force transmitted by the helical spring 16, 16′ to the second thrust ring 14.

The term “secured” should thus be understood to mean that, for example when using the clamping/separating system 10, the first thrust ring 13 may be kept in contact with the first half-body 6 and the second thrust ring 14 may be kept in contact with the clamping piece or pieces 11.

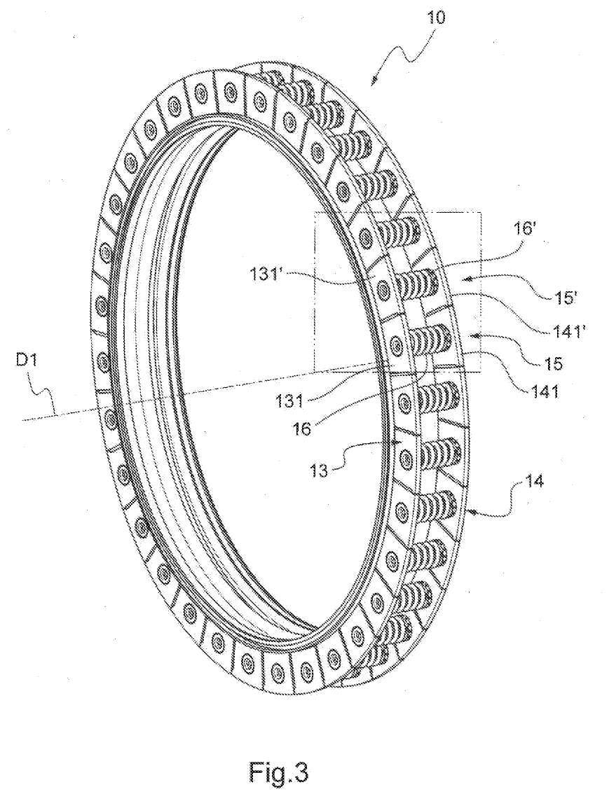

As shown in greater detail in FIGS. 3 to 6, such a clamping/separating system 10 comprises at least one assembly 15, 15′ that is elastically deformable by compressing comprising a helical spring 16, 16′ and a guide shaft 17, 17′ comprising an axis of revolution R1, R2 oriented parallel to the translation direction D1.

The helical spring 16, 16′ of each assembly 15, 15′ is thus arranged between the first thrust ring 13 and the second thrust ring 14 and also extends around the guide shaft 17, 17′.

As shown, the first thrust ring 13 and the second thrust ring 14 also cooperate with the sealing sleeve 12.

Such a sealing sleeve 12 comprises a first annular portion 121 and a second annular portion 122 and a deformable portion 123 arranged between the first annular portion 121 and the second annular portion 122. Such a deformable portion 123 may also comprise corrugations 124, 125 formed by a metal sheet having symmetry of revolution centered around the translation direction D1 of the in-line seal 1.

The first annular portion 121 cooperates with a first cylindrical portion 130 of the first thrust ring 13 and the second annular portion 122 cooperates with a second cylindrical portion 140 of the second thrust ring 14.

As shown in greater detail in FIG. 3, the in-line seal 1 may comprise a plurality of assemblies 15, 15′ arranged equidistant from each other in azimuth about the translation direction D1.

Such an arrangement of the different assemblies 15, 15′ makes it possible, in particular, to remove any assembly 15, 15′ from the in-line seal 1 in order to replace a helical spring 16, 16′.

In order to do this, the first thrust ring 13 comprises several first sections 131, 131′ arranged equidistant from each other in azimuth about the translation direction D1 and the second thrust ring 14 also comprises several second sections 141, 141′ arranged equidistant from each other in azimuth about the translation direction D1.

Therefore, when an operator wishes to replace the spring 16, a first section 131 of the first thrust ring 13 and a second section 141 of the second thrust ring 14 are also removed from the in-line seal 1. One or more grooves may be provided between two consecutive first sections 131, 131′ and/or between two consecutive second sections 141, 141′ in order to make these sections easier to grip independently of each other.

Therefore, an assembly 15, a first section 131 of the first thrust ring 13 and a second section 141 of the second thrust ring 14 form a group of pieces that are linked to each other and can be deformed in compression and expansion along an axis of translation that coincides with the axis of revolution R1.

Furthermore, notches 132, 132′, 142, 142′ may be provided between each of the first sections 131, 13′ and/or between each of the second sections 141, 141′ in order to make it easier to radially install or grip each of the groups of pieces next to each other around the translation direction D1.

Furthermore, each assembly 15, 15′ then cooperates with a first section 131, 131′ of the first thrust ring 13 and a second section 141, 141′ of the second thrust ring 14. Each first section 131, 131′ is also arranged respectively opposite a second section 141, 141′ along the axis of revolution R1, R2 of the guide shaft 17, 17′.

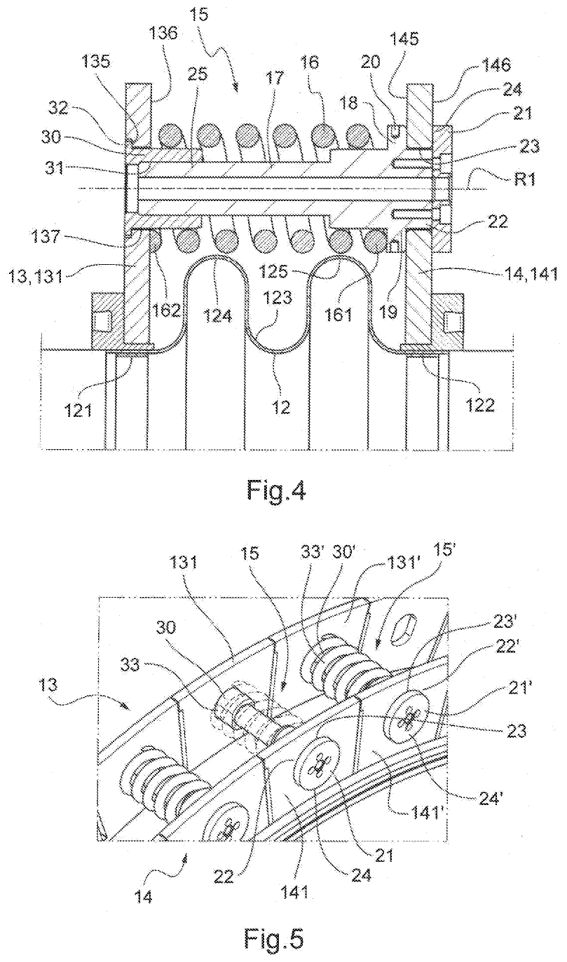

As shown in FIG. 4, each guide shaft 17 may comprise a head 18 having a degree of rotational freedom in relation to the second thrust ring 14, the degree of rotational freedom being about an axis of rotation AXROT1 that coincides with the axis of revolution R1.

The head 18 may comprise a first shoulder 19 bearing against a first end 161 of the helical spring 16 and against a first face 145 of said second thrust ring 14.

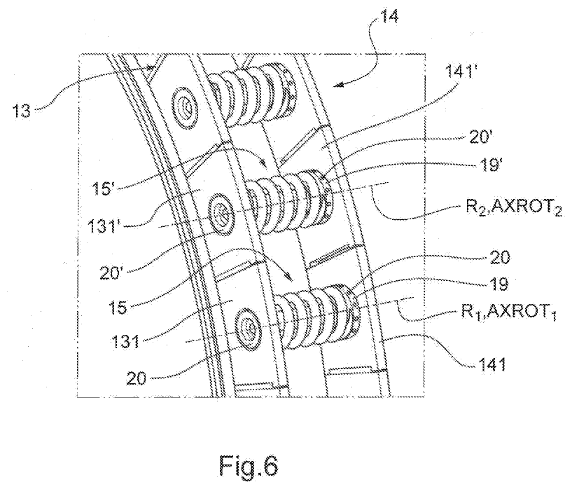

As shown in FIG. 6, such a first shoulder 19, 19′ may comprise a plurality of holes 20, 20′ arranged radially in relation to the axis of revolution R1, R2 and equidistant in azimuth. These holes 20, 20′ may enable an operator to rotate the guide shaft 17, 17′ about the axis of rotation AXROT1, AXROT2 in relation to the second thrust ring 14 with a tool that is not shown that may, for example, be in the form of a rod or a bar, so as to cooperate with each hole 20, 20′ of a given guide shaft 17, 17′, one after another.

Moreover, and as shown in FIG. 5, each assembly 15, 15′ may comprise an axial stop 21, 21′ secured to a cylindrical portion 22, 22′ of the head 18, 18′. Such a cylindrical portion 22, 22′ extends along the axis of revolution R1, R2 from the first shoulder 19, 19′.

This cylindrical portion 22, 22′ may therefore pass through a matching cylindrical bore 23, 23′ provided in said second thrust ring 14. Furthermore, such an axial stop 21, 21′ comprises a second shoulder 24, 24′ intended to come into contact with a second face 146 of the second thrust ring 14.

Such a second face 146 may be arranged parallel to the first face 145 and perpendicular to the axis of revolution R1, R2.

Moreover, such an assembly 15, 15′ may comprise a nut 30, 30′ having a tapped bore 31, 31′ screwed onto a threaded portion 25, 25′ of the guide shaft 17, 17′. Such a nut 30, 30′ is secured to the first thrust ring 13 without any degree of freedom under a tensile reaction transmitted by the guide shaft 17, 17′ to the nut 30, 30′. Furthermore, such a tensile reaction counters the compression force transmitted by the helical spring 16, 16′ to the first thrust ring 13 and to the second thrust ring 14.

Therefore, a third shoulder 32 may be provided on the nut 30, 30′ to come into contact with a first face 135 of the first thrust ring 13 and one or more flat spots 33, 33′ may be provided on the nut 30, 30′ to cooperate with a matching bore 137.

The first thrust ring 13 may also comprise a second face 136 against which a second end 162 of the spring 16, 16′ may come to bear in order to transmit a compression force.

Such a second face 136 may be arranged parallel to the first face 135 and perpendicular to the axis of revolution R1, R2.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

1. An in-line seal comprising:
a sealing plate that is able to move in a plane between a sealing position preventing fluid flow in an internal zone of the in-line seal and a flow position allowing the fluid flow in a direction of fluid flow, the sealing plate comprising a solid portion for preventing the fluid flow and a perforated portion for allowing the fluid flow;
a body comprising a first half-body and a second half-body arranged respectively on either side of the plane, the first and second half-bodies respectively having a first opening and a second opening allowing the fluid flow; and
a clamping/separating system for clamping and, conversely, for separating at least one clamping piece, the at least one clamping piece being able to move in relation to the body according to at least one degree of freedom to move in translation in a direction of translation parallel to the direction of fluid flow, the at least one clamping piece being arranged between the sealing plate and the first half-body, the clamping/separating system comprising an elastically deformable sealing sleeve extending between the first half-body and the at least one clamping piece the clamping/separating system comprising a first thrust ring secured to the first half-body, a second thrust ring secured to the at least one clamping piece, a plurality of assemblies that are elastically deformable by compressing and arranged equidistant from each other in azimuth about the translation direction, each assembly comprising a helical spring and a guide shaft comprising an axis of revolution oriented parallel to the translation direction the helical spring being arranged between the first thrust ring and the second thrust ring, the helical spring being arranged around the guide shaft,
wherein the first thrust ring comprises several first sections arranged equidistant from each other in azimuth about the translation direction and the second thrust ring comprises several second sections arranged equidistant from each other in azimuth about the translation direction.

2. The in-line seal according to claim 1,
wherein the guide shaft comprises a head having a degree of rotational freedom in relation to the second thrust ring, the degree of rotational freedom being about an axis of rotation that coincides with the axis of revolution.

3. The in-line seal according to claim 2,
wherein the head comprises a first shoulder bearing against a first end of the helical spring, and against a first face of the second thrust ring.

4. The in-line seal according to claim 3,
wherein the first shoulder comprises a plurality of holes arranged radially in relation to the axis of revolution and equidistant in azimuth, the plurality of holes allowing the guide shaft to be rotated about the axis of rotation and in relation to the second thrust ring with a tool.

5. The in-line seal according to claim 3,
wherein the at least one assembly comprises an axial stop secured to a cylindrical portion of the head, the cylindrical portion extending along the axis of revolution from the first shoulder the cylindrical portion passing through a matching cylindrical bore provided in the second thrust ring, the axial stop comprising a second shoulder in contact with a second face of the second thrust ring, the second face being arranged parallel to the first face and perpendicular to the axis of revolution.

6. The in-line seal according to claim 1,
wherein the at least one assembly comprises a nut with a tapped bore screwed onto a threaded portion of the guide shaft the nut being secured to the first thrust ring without any degree of freedom under a tensile reaction transmitted by the guide shaft to the nut.

7. An The in-line seal according to claim 1,
wherein each assembly of the plurality of assemblies cooperates with a first section of the first thrust ring and a second section of the second thrust ring, the first section being arranged opposite the second section along the axis of revolution of the guide shaft of the assembly.

8. An in-line seal according to claim 1,
wherein the sealing sleeve comprises a first annular portion cooperating with a first cylindrical portion of the first thrust ring and a second annular portion cooperating with a second cylindrical portion of the second thrust ring.
